(19) United States
(12) Patent Application Publication
(10) Pub. No.: US 2012/0302666 A1
(43) Pub. Date: Nov. 29, 2012

(54) WALL BASE AND FORMULATION FOR MAKING THE SAME

(75) Inventors: Jeffrey A. Robinette, Akron, OH (US); Joseph H. Nogosek, Ashland, OH (US)

(73) Assignee: Johnsonite Inc., Chagrin Falls, OH (US)

(21) Appl. No.: 13/576,476

(22) PCT Filed: Jan. 26, 2011
(86) PCT No.: PCT/US11/00147

§ 371 Date: Aug. 1, 2012

Related U.S. Application Data
(60) Provisional application No. 61/337,285, filed on Feb. 1, 2010.

(51) Int. Cl. C08K 13/08; C08L 9/00

(52) U.S. Cl. 523/219

(57) ABSTRACT

A composition for manufacturing flooring accessories, such as a wall base, and process for manufacturing the composition. The composition includes a first formulation and a second formulation that are cured together by a partial cure. The composition incorporates rapidly renewable materials, natural filler materials and has a low weight per linear foot.

### CROSS-REFERENCE TO RELATED APPLICATION

This application is a National Stage application of International Application No. PCT/US2011/000147, filed on Jan. 26, 2011, which claims priority of U.S. Provisional Application No. 61/337,285, filed Feb. 1, 2010, under Title 35, United States Code, Section 119(e), both of which are incorporated herein by reference in their entireties.

### FIELD OF THE INVENTION

The present invention generally relates to compositions or formulations for manufacturing building construction materials. More particularly, the present invention relates to a plastic polymeric composition or formulation for manufacturing building construction materials which are halogen-free, phthalate-free, reprocessable and rapidly renewable. The composition can include a blend of polymers, which may include at least one polyolefin material.

### DESCRIPTION OF THE PRIOR ART

Construction, flooring and building materials, such as flooring accessories including wall bases, crown moldings, chair rails, flooring tiles, and the like, are well known in the art. Moreover, various extrudeable formulations for manufacturing such construction, flooring and building materials are also well known in the art. An issue with conventional formulations for manufacturing such construction, flooring and building materials is that many such formulations are not easily recyclable and do not contain a rapidly renewable content. An issue with improving such conventional formulations for manufacturing such construction, flooring and building materials is that many conventional improvements tend to be cost-prohibitive or are difficult to manufacture, while at the same time can be difficult to meet all aesthetic and building code specification requirements. In addition, there is a segment of the relevant market that prefers such products to be devoid of halogens and phthalates.

For example, many solutions for addressing the problems with conventional formulations for manufacturing such construction, flooring and building materials include using and selling formulations which are PVC-based compounds or a cured rubber. However, PVC-based compounds typically contain phthalates as the common plasticizers. Phthalates, or phthalate esters, are esters of phthalic acid and are mainly used as plasticizers, i.e., substances added to plastics to increase their flexibility, transparency, durability, and longevity. The most commonly-used phthalates are the di-2-ethyl hexyl phthalate (DEHP), the diisodecyl phthalate (DIDP) and the diisononyl phthalate (DINP). DEHP is the dominant plasticizer used in PVC due to its low cost. Benzylbutylphthalate (BBP) is used in the manufacture of foamed PVC, which is mostly used as a flooring material.

Various alternative rubber-based materials have been developed and are employed in the art to address a market preference for conventional formulations that do not contain halogens and phthalates. For example, other rubber-based materials are typically thermoset using amine/sulfur based curing systems and salt bath and/or fluid beds with microwave curing units which require high energy consumption. Other plastic-based formulation solutions tend to be cost-prohibitive, or fail due to poor aesthetic qualities, poor durability, high stiffness (low flexibility), and failure to meet industry standards for flame retardant/smoke resistance requirements. One disadvantage with conventional formulations is that many are not easily recyclable or reprocessable.

A disadvantage with employing an olefin-based polymer is that the costs of the olefin and the costs for ensuring proper flame retardants tend to be high and thus cost-prohibitive. For example, it is known in the electrical industry to extrude large reels of low voltage wire and cable covered with a soft olefin or rubber base having a lower flame retardancy requirement. However, such use of these materials is typically too stiff or too resilient for use in the field of the present invention, and in particular in formulations for manufacturing flooring materials, such as wall base. Dynamically vulcanized alloys and high temperature plastics are sold to mimic the properties that are required in such areas as materials for making flooring materials. However, such materials fail to consistently meet the relevant ASTM and IBC requirements and prove to be cost-prohibitive. Standard plastics, which meet the requirements for withstanding temperature, flame and smoke, typically include too high of a molecular weight and hardness for meeting the aesthetic and installation requirements.

In regards to standard specifications for resilient wall base materials, the relevant ASTM standard specification is the ASTM designation F 1861-02. Wall base, as known in the art, provide a functional and decorative border between walls and floors. This standard specification calls for various classifications of wall base types, groups and styles as provided below. ASTM requirements specify that any polymeric material or combination of polymeric materials is acceptable if, in combination with processing chemicals, fillers and colorants, the material can be formed into wall bases, which satisfies all the requirements of this standard specification. Other suitable recycled polymeric material or materials may be incorporated as a part of the total polymeric content. The ASTM wall base standard classification is as follows:

| Type | Composition |
|---|---|
| Type | Rubber, vulcanized thermoset. The polymeric binder of this |
| TS | compound shall satisfy the definition of rubber and have been |
| | vulcanized, as defined in Terminology D 1566. |
| Type | Rubber, thermoplastic. The polymeric binder of this compound |
| TP | shall satisfy the definition of rubber, but remain thermoplastic, as |
| | defined in Terminology D 883. |
| Type | Vinyl, thermoplastic. The polymeric binder of this compound |
| TV | shall satisfy the definition of poly (vinyl chloride) in Terminology |
| | D 883 and Specification D 1755 but remain thermoplastic as |
| | defined in Terminology D 883. |

| | Configuration |
|---|---|
| Group | |
| Group 1 | Solid (homogenous) |
| Group 2 | Layered (multiple layers) |
| Style | |
| Style A | Straight |
| Style B | Cove |
| Style C | Butt-to |

ASTM standards also call for specific performance requirements.

Flexibility—Unless otherwise specified in contract or order, the wall base shall show no visible cracks, breaks or other evidence of weakness when tested in accordance with Test Method F 137 using a ¼ in. (6.35 mm) diameter mandrel.

Staining of Adjacent Surfaces Induced by Wall Base—Wall base shall contain no ingredient which will cause staining of the finished surfaces adjacent to it when aged by the method specified in 12.1-12.7.

Resistance to Light—When tested in accordance to Test Method F 1515, the color change of the wall base shall have an average AE no greater than 8.0 after 200 h of exposure to light, simulated by a properly fitted xenon-arc radiant energy source.

Resistance to Chemicals—When tested in accordance with Test Method F 925, the wall base shall have no more than a slight change in surface dulling, surface attack or staining when exposed to the following chemicals: white vinegar (5% acetic acid), rubbing alcohol (70% isopropyl alcohol), white mineral oil (medicinal grade), sodium hydroxide solution (5% NaOH), hydrochloric acid solution (5% HCl), sulfuric acid solution (5% H₂SO₄), household ammonia solution (5% NH₄OH), household bleach solution (5.25% NAOCl), olive oil (light), kerosene (K1), unleaded gasoline (regular grade)

Dimensional Stability—Wall base shall not change in length by more than +/−0.25% when tested by the method specified in 12.8-12.15.

Odor—The wall base shall be free from offensive odor.

Conventional methods for addressing the aforementioned issues include the use of polypropylene and EPDM materials. However, the surface activity of the polypropylene and EPDM materials is so low that the foregoing materials are not normally employed in formulations for manufacturing flooring materials, in particular wall bases, since such formulations traditionally exhibit poor adhesive qualities. Often times, plasma treatments are employed to activate the surface to improve adhesion. However, the activated surface charge ultimately dissipates over time, such as extended storage in a warehouse, and the product could fail adhesion requirements during use.

U.S. Pat. Nos. 6,838,540 and 7,566,761 (both to Mitani, et al.) are related patents which disclose an olefin polymer and a process for preparing an olefin polymer. Both of these patents essentially state that it would be known in the art of manufacturing building materials to incorporate the use of olefin copolymer for making baseboards. However, both references say that the olefin copolymer can be used as a modifier for rubbers, including crosslinked rubbers, natural rubber, isoprene rubber, butadiene rubber, styrene/butadiene rubber, chloroprene rubber, acrylonitrile/butadiene rubber, butyl rubber, ethylene/propylene rubber, chlorosulfonated polyethylene, acrylic rubber, epichlorohydrin rubber, silicone rubber and flurorubber, as well as thermoplastic rubbers, such as styrene type, olefin type, urethane type, ester type, amide type and vinyl chloride type. Olefin-based polymers are relatively expensive, and expense must be made to make them sufficiently flame retardant. Moreover, olefin-based polymers are either too stiff, too resilient and too hard to be a practicable material for making flooring accessories, especially wall bases.

U.S. Pat. Nos. 6,910,307 and 6,918,977 (both to Maurer) are similar patents which teach an architectural molding having an extrudable plastic foam member having a front side, a rear side and a cross-sectional profile. The molding also allegedly includes a layer of pressure-sensitive adhesive affixed to at least a portion of the rear side and a release strip releasably adhered to the layer of the pressure-sensitive adhesive. Both references state that the use of a flexible plastic foam for use in the building construction device may be polyethylene, rubber latex, polypropylene, polyurethane, polyvinyl chloride or polyolefin flexible plastic foam, and more preferably polyethylene flexible plastic foam, especially made with an isobutene blowing agent. The references, however, describe PSA adhesives on a foamed base, which is avoided with the present invention due to the fact that no PSA adhesive is used.

U.S. Pat. No. 5,298,544 (Goff) teaches a non-halogen flame retardant thermoplastic composition. The disclosure is directed to a non-brominated flame retardant thermoplastic composition, and more particularly to the use of certain magnesium compounds in combination with another component as flame retardants for copolyetherimide esters and copolymer esters. The magnesium compound is magnesium carbonate or blends thereof, with other components consisting of calcium carbonate, and zinc borate or zinc oxide or a mixture thereof.

Goff recites a co-polyester with a common flame retardant system, such as magnesium carbonate with zinc borate which is well known in the art. Magnesium carbonate with zinc borate as a flame retardant system is avoided in a flame retardant system of the present invention because magnesium carbonate is not used.

U.S. Pat. No. 5,700,865 (Lundquist) describes a flooring material that comprises 30-70 parts by weight of a copolymer of ethylene and an α-olefin having 4-10 carbon atoms, preferably an ethylene/octene copolymer, 20-40 parts by weight of polypropylene, 5-20 parts by weight of a crosslinked ethylene polymer, preferably a copolymer of ethylene and an ethylenically unsaturated silane compound, 10-25 parts by weight of an organic filler, preferably polyethylene having a melt index below 0.1 g,/10 min (190° C./21.6 kg) and a phase stability in the flooring material of at least about 200° C., 0.2-7 parts by weight of a flame retardant, preferably silicone and magnesium stearate, 0.1-2 parts by weight of an antistatic agent, and 0.1-1 part by weight of a stabilizer. The flooring material is free from inorganic fillers. The description of the material allegedly obviates the drawbacks of the prior art by providing a halogen-free flooring material which is not based on PVC and, in addition, is free from inorganic fillers. This aim is supposedly achieved by a flooring material comprising a defined composition of olefin polymers in combination with an organic filler and certain additives. According to the description in the Lundquist patent, the organic filler preferably is a polymer material selected from one or more of starch, cellulose and polyethylene. Preferably, the organic metal salt is magnesium stearate. Octene is a preferred α-olefin comonomer.

An issue of the Lundquist description is that the polypropylene can be broken in its chain length by the cure system employed and the invention addresses linking this broken chain length by some another means to toughen the base materials. This material is not employed with the present invention.

U.S. Pat. No. 5,910,358 (Thoen, et al.) teaches PVC-free foamed flooring and wall coverings. The disclosed product is stated to be a resilient cushion foam flooring and wall product that is free of PVC, plasticizers and heavy metal stabilizer. In particular, the wall covering product is free of PVC and plasticizers and comprises a thermoplastic top covering layer integrated with a latex or thermoplastic foam backing layer. The product is a substantially olefinic, substantially melt processed resilient cushion foam flooring and wall covering product. Thoen, et al. also describes a method for making the product. The product is allegedly free of PVC and plasticizers and is substantially recyclable, or at least can be incinerated. The floor and wall covering product disclosed in the Thoen, et al. patent has a resilient cushion foam backing layer which is integrated with a top structure. The top structure is a substrate for the resilient cushion foam backing layer and comprises a transparent polymeric upper wear layer, a polymeric print layer and an optionally polymeric or textile intermediate reinforcement layer. The transparent upper wear layer provides good scratch and abrasion resistance. The resilient foam backing layer consists of a solvent dispersed polyolefin polymer, and a melt processed polyolefin polymer or a latex composition. The latter patent differs from the present invention in that it teaches the vinyl aromatic monomer for the latex composition may be selected from styrene, alpha-methylstyrene, etc. The reference also states that textile substrate layers, and inorganic fillers such as calcium carbonate may be added to the latex composition. The patent includes a catalytic curing agent which is used to chemically cross-link a basis for the foam.

U.S. Pat. No. 7,354,656 (Mohanty, et al.) pertains to a floor covering made from an allegedly environmentally friendly polylactide-based composite formulation. The polymeric materials include a polylactic acid-based polymer in combination with a plasticizer and a compatibilizer, and an optional filler. The polymeric material can include, inter alia, polyolefins modified with polar groups, for example, ionomers. The plasticizer is typically an epoxidized vegetable oil or esterified and epoxidized vegetable oil. The compatibilizer can be a polyolefin modified with one or more polar functional groups. The patent states that the product can include additional layers which include the polymeric material, or where the polymeric material is mixed with cellulosic fibers, like kenaf, industrial hemp, flax, jute, sisal, henequen, wood fiber, grasses and straws to form composites, such as natural/cellulose fiber composites. Allegedly suitable polymeric resins include relatively polar polymers that are miscible with the polylactide, such as polyolefins modified with polar groups such as maleic anhydride and others. However, plasticizers capable of plasticizing the polylactic acid-based materials can be used, such as plasticizers selected from phthalates. Phthalates would not be included with the present invention. This patent also discloses the use of PLA used with ionic materials (e.g., modified olefins like ionomers), which are in no way involved with the present invention.

U.S. Pat. No. 4,151,319 (Sackoff, et al.) discloses a method for making a pressure sensitive adhesive coated laminate. The patent is directed to a method that involves the intimate mixing with the pressure sensitive adhesive prior to coating onto the release surface of a means for decreasing the “zero minute peel value” of the facing layer-pressure sensitive adhesive layer combination. Specifically, the material used to decrease the “zero minute peel value” is a polysiloxane and must be capable of being intimately mixed and dispersed throughout the pressure sensitive adhesive. By virtue of the intimate mixing of the polysiloxane material with the pressure sensitive adhesive, the need for a separate and precisely controlled coating step wherein the polysiloxane is applied to the pressure sensitive adhesive is allegedly obviated.

U.S. Pat. No. 5,276,082 (Forry, et al.) teaches compositions which utilize copolymers of ethylene and vinyl acetate, silane-grafted copolymers of ethylene, vinyl acetate and terpolymers of ethylene, vinyl acetate and carbon monoxide or methacrylic acid. These copolymers or various blends of these polymers are compounded with fillers such as calcium carbonate. These compositions are characterized by being halogen-free. However, the patent discusses that common plasticizers such as di-2-ethylhexyl phthalate or butyl benzyl phthalate have been employed with varying degrees of compatibility.

Silane grafted EVA, with a phthalate as a plasticizer is taught in the Forry, et al. patent and is specifically avoided by the present invention. Silane grafted ethylene copolymers are an essential component of the Forry, et al. patent, and these copolymers are not used or created by the present invention.

U.S. Pat. No. 6,312,777 (Smith) teaches a method for making an improved pressure sensitive adhesive coated laminate involving coating a sheet having a release surface thereon with a pressure sensitive adhesive to form a laminate, drying or curing the pressure sensitive adhesive and marrying the laminate to the inner surface of a facing layer. The patent is essentially a coated transfer adhesive used as a PSA. Dimethylsiloxanes are employed to allow repositioning.

U.S. Pat. No. 6,833,413 (Sasagawa, et al.) is a patent that teaches a block copolymer being a hydrogenated block copolymer capable of obtaining a molded product, as a polyolefin based resin composition, allegedly having an excellent physical property balance between impact resistance, rigidity and molding processability. The product allegedly can be used, for example, as a backside glue for fixing lightweight plastic molded products. This patent pertains to block copolymers, e.g., SEBS and SBS, as well as hydrogenated versions of the block copolymers.

U.S. Pat. No. 7,524,910 (Jiang, et al.) pertains to an article comprising a polymer comprising one or more C₃ to C₄₀ olefins, optionally one or more diolefins, and less than 5 mole % of ethylene having Dot T-Peel of 1 Newton or more, a branching index (g′) of 0.95 or less measured at the Mz of the polymer and an Mw of 100,000 or less. In particular, the reference teaches a very specific polymer comprising one or more C3 to C40 olefins where the polymer has (a) a Dot T-Peel of 1 Newton or more on Kraft paper, (b) a branching index (g′) of 0.95 or less measured at the Mz of the polymer, (c) a Mw of 10,000 to 100,000 and (d) a heat infusion of 1 to 70 J/g. This patent talks about the polymerization process and features a description of the use of isotactic blends to make an adhesive. The foregoing polymerization process and the use of isostatic blends are not used with the present invention.

U.S. Published Application No. 2007/0270538 (Somers, et al.) discusses elastomeric compositions comprising at least one polymeric elastomer, at least one propylene polymer and at least one curing agent, and which elastomeric compositions can be used in vinyl floor tile adhesives. The elastomeric polymer is produced from a polymerization reaction of at least one monoolefin monomer and at least one multiolefin monomer. The compositions discussed in this publication are contrary to the present invention in that the elastomeric polymer can include halogenated butyl rubber, star-branched versions of these rubbers and brominated isobutylene-co-para-methystyrene or blends thereof.

U.S. Published Application No. 2009/0136774 (Onogi, et al.) teaches a resin composition comprising a polyolefin and an olefinic block copolymer. The olefinic block polymer comprises as a constitutional unit, a block which is a polyolefin component and a block which is a polymer unit composed of a vinyl monomer having a solubility parameter of from 18 to 25 J/m. The composition can be used for flooring and baseboards. The foregoing composition is not like the present invention since the patent discusses the use of a grafted polymer system, as well as the use of halogen-based laminates.

In view of the current state of the art, there is a need to provide a wall base product that has a better performance than conventional wall base products, which is rapidly renewable, has good strength and flexibility, is impact resistance, stain resistance, and smoke/flame resistance, while overcoming all of the disadvantages as described above and which addresses a preference of a segment of the relevant market to be devoid of halogens and phthalates.

Accordingly, there is an unsatisfied need for a cost-efficient and easily manufactured non-PVC formulation for manufacturing wall base and other flooring and building materials which is free of phthalates, free of halogens and which is easily recyclable and reprocessable (and has a rapidly renewable content), and which meets all relevant ASTM and building code specifications.

### SUMMARY OF THE INVENTION

In accordance with a preferred embodiment of the present invention, there is provided a plastic polymeric formulation or composition comprising an olefinic-EPDM (rubber) base material for manufacturing flooring materials, such as a wall base. The formulation may comprise a thermoset or thermoplastic olefin-based polyoctene ethelene/EVA and EPDM/butyl rubber. The formulation meets requisite flame retardant specifications according to the International Building Code (IBC) and ASTM requirements, is sufficiently soft and flexible, and can be used to provide aesthetic products. The formulation or composition can be employed to manufacture building materials, such as a wall base or floor tile, having a weight per linear foot that is advantageously lower than a conventional wall base.

The present invention addresses a need in the manufacture of flooring and construction materials, such as wall bases, for improving the conventional technology of using cured rubber and/or thermoplastic formulations which can be relatively hard or rigid. The present invention is a rubber-based polymer blend which facilitates the material being extruded and allows for the reduction in process steps, processing time and specific gravity (i.e., increased parts per pound) thereby yielding an overall cost reduction. The formulation of the present invention can be produced in any desirable color(s), is extrudeable, can be manufactured with reduced processing steps and at higher throughput speeds for simplified processing, contains a cured (i.e., vulcanized) component, is devoid of certain common rubber processing additives such as amine accelerators, natural rubber allergens, sulfur, phthalates, halogens and/or bovine spongiform encephalopathies. The present formulation is also dual extruded to prevent natural materials/components in the back layer from degrading the surface or appearance in any longer-term aging conditions.

The formulation according to a preferred embodiment of the present invention may be employed for manufacturing flooring materials and comprises a renewable content that meets any relevant environmental standards, such as at least 10% of a renewable content, at least 5% of which is a plant-based rapidly renewable content, is rubber-based, is completely recyclable, contains an aesthetic and smooth, scratch resistant finish and improves the low surface activity which is inherent in base olefins.

The invention in a preferred form is a formulation for the preparation of flooring and other building construction materials, such as, for a wallbase. The formulation could also be employed for the manufacture of chair rails, flooring and floor tiles, crown molding and the like. The wall base comprises a back layer having a hot melt or hot melt-like component for promoting or facilitating adhesion, and a top coat layer. The hot melt or hot melt-like component of the back layer comprises a hot-melt adhesive for bonding with an acrylic adhesive in the top coat formulation.

The synthetic polyoctene-rubber wallbase contains a renewable raw material content. Plastic extrusion processing costs and the specific gravity are significantly lower than those in either standard PVC wall bases, or those made of a cured rubber. The purpose of the present invention is to provide a simplified process which eliminates certain characteristics which are present in standard and conventional rubber-based materials, such as, for example, no curing baths, no potentially undesirable curing ingredients, and a lower energy requirement to produce. Ethylene- and propylene-based plastic is inherently clean and is devoid of certain extractables and byproducts of the standard rubber processing protocols. The present invention also seeks to allow the use of alternative natural materials to provide a basic renewable content of at least 10%. Such alternative methods would yield a reduction in both material cost and processing complexity for improved manufacturing.

The use of the thermoplastic olefinic- and rubber-based polymer combination can be adapted to both conventional processes and/or improved plastic extrusion processes using a single step manufacturing method. Such use reduces material consumption and reduces energy consumption. The material for the inventive formulation can be processed using a standard rubber or plastic co-extrusion or single extrusion of the substrate, such as low-level extrusion curing of the plastic component within a rubber polymer matrix.

The formulation according to the present invention can also be applied for use with other applications, such as light-weight foam versions for use in crown molding, and extruded tiles or, via the employment of higher homopolymer polymers for providing increased hardness, for use in low density light weight wall bases. For example, a lower density would also allow for higher output speeds at about the same pounds per hour from the extruder.

The present invention also relates to methods of making the inventive compositions/formulations, as well as methods for making the flooring accessories, such as a wall base.

The wall base back layer includes a built-in hot melt type of adhesive component which will bond with standard adhesives for solving the problems inherent with low surface energy materials. The backlayer formulation further includes a material(s) for facilitating a rapidly renewable quality, such as a plant-based material, including vegetable oil, walnut shell, pine tar (pine sap), rosin and paper (such as wood or plant fiber). The backlayer formulation still further includes a material(s) for facilitating a renewable quality, such as oyster shell (e.g., calcium carbonate).

The formulation according to a preferred embodiment of the present invention for the top coat of a multi-coat flooring accessories material meets all relevant ASTM and building code requirements. In particular, the formulation for the polymer-based backlayer is a rubber (such as EVA (ethylene vinyl acetate), EPDM (ethylene propylene diene monomer, polyoctene ethylene) and olefin material (such as polypropylene), along with another olefin material and an oil (such as baby oil, mineral oil, paraffin) as a plasticizer. The top coat and backlayer formulations are devoid of phthalates. The top coat and backlayer formulations are also devoid of any halogens while maintaining sufficient flame retardant qualities along with sufficient material flexibility. A compatibilizer material, such as an elastomeric and polyolefinic polymer (i.e., EXXELOR®) is employed to bind-in the flame retardant materials.

In order to optimize the backlayer flexibility, the vulcanized vegetable oil and pine tar rosin are included with the backlayer formulation. According to one non-limiting embodiment of the present invention, the ingredients are combined to arrive at a top coat and backlayer formulation that is non-halogenic, phthalate-free, reprocessable and is rapidly renewable while meeting all relevant ASTM and building code requirements.

The top coat formulation according to the last-mentioned preferred embodiment also includes a material(s) for facilitating good durability (i.e., scratch resistance) and good appearance (i.e., stress whitening resistance). An additive, such as IRGASURF®, ADMER® or Dow Corning® MB50-001 Masterbatch, is combined with a wax for improving the surface durability and appearance.

In curing the formulation, the compound contains an in-situ low level cross-link plastic cure (i.e., a partial cure). A part of the plastic system is cross-linked or gelled for adding durability and structure to the formulation. To achieve this, two reactive polyethylenes (such as GMA and MAH) react with each other in the presence of heat so that they melt and cure together. This feature of the invention is novel in that such curing is not typically employed for the manufacture of the present products, i.e., flooring accessories and particularly wall bases.

Another feature of a preferred embodiment of the present invention is a wall base characterized by being devoid of PVC, phthalates and any halogen, and that has acceptable performance qualities, such as impact resistance, crack resistance, stain resistance, heat and light resistance, smoke resistance, flame retardancy, low maintenance, good flexibility and the like, as well as being reprocessable.

An additional feature of a preferred embodiment of the present invention is a wall base product being devoid of halogens and phthalates that can be processed via traditional manufacturing processing and equipment.

Another feature of a preferred embodiment of the present invention is an olefin-based formulation for manufacturing a wall base at a relatively low cost.

Yet another feature of a preferred embodiment of this invention is the improvement of the adhesion between the final product and the adjacent wall when a low surface energy polymer is employed in the manufacture of the present invention.

Still yet another feature of a preferred embodiment of the present invention is the development of a formulation for the manufacture of a wall base that contains a rapidly renewable content while meeting all relevant building code and ASTM requirements and specifications.

Another feature of the present invention relates to methods of making the compositions/formulations, as well as methods for making the flooring accessories, such as a wall base.

Additional features and advantages of the present invention will be set forth in the description which follows, and, in part, will be apparent from the description and the appended claims, or may be learned by practice of the present invention. The features and other advantages of the present invention will be realized and attained by means of the elements and combinations particularly pointed out in the written description and the claims.

To achieve these and other objects and advantages, and in accordance with the purposes of the present invention as embodied and broadly described herein, the present invention relates to a wall base comprising a back layer and a top layer (or top coat), and a formulation or composition for manufacturing each of the back layer and the top layer.

It is an object of the present invention to provide a formulation or composition for manufacturing flooring accessories which is cost efficient.

It is another object of the present invention to provide a formulation or composition for manufacturing flooring accessories which meets relevant IBC, ASTM, aesthetic quality, flame retardant, smoke, durability, flexibility and resiliency requirements.

It is yet another object of the present invention to provide a formulation or composition for manufacturing flooring accessories which are recyclable and contain a rapidly renewable content/rapidly renewable materials and natural filler materials.

It is another object of the present invention to provide a formulation or composition for manufacturing flooring accessories which exhibit sufficient adhesion characteristics.

It is yet another object of the present invention to provide a formulation or composition for the manufacture of flooring accessories having an integral adhesive component therein.

It is still yet another object of the present invention to provide a formulation or composition for the manufacture of building materials, such as flooring accessories including wall bases and floor tiles, which are devoid of phthalates and halogens.

It is yet another object of the present invention to provide a formulation or composition for the manufacture of building materials, such as flooring accessories including wall bases or floor tiles, which have a lower weight per linear foot than conventional building materials.

It is to be understood that both the foregoing general description and the following detailed description are exemplary and explanatory only and are intended to provide a further explanation of the present invention, as claimed.

Other objects of the present invention will become apparent from the description to follow and from the appended claims.

### BRIEF DESCRIPTION OF THE DRAWINGS

FIG. 1 is a schematic view of an assembly line for performing a process for manufacturing the composition in accordance with the present invention.

### DETAILED DESCRIPTION OF THE PREFERRED EMBODIMENTS

The present invention is now described in its preferred forms. In the following description, for purposes of explanation, numerous specific details are set forth in order to provide a thorough understanding of the present invention. It will be evident, however, to one skilled in the art that the present invention may be practiced without these specific details.

In one aspect, the present invention relates to a composition, and, particularly, an olefin based composition, for the manufacture of building and flooring materials, such as a wall base and floor tile.

“Phr,” as used herein, refers to “weight parts per hundred of rubber” as is well known in the art.

The term “olefin based composition” refers to an olefin-containing composition suitable for forming a base, substrate, or backing of a laminate, although that application of the formulation is not necessarily required. The compatibilizer comprises at least one polyolefin having at least one polar group.

The term “compatibilizer” is referred to herein as an additive that, when added to a blend of immiscible polymers, modifies their interfaces and/or stabilizes the blend. The compatibilizer, therefore, can permit or improve the adhesion between dissimilar compositions and/or layers of materials.

A “plasticizer,” as referred to herein and unless defined differently in context, is an additive that increases the plasticity or fluidity of the material to which they are added or for softening the final product to increase its flexibility.

In one aspect, the preferred embodiments of the present invention relates to an olefin based composition or formulation for forming a backing layer for the manufacture of a building component, such as a wall base, the composition comprising at least one olefin-based polymer, at least one second polymer being different or the same as the first polymer, at least one rubber-based material, at least one compatibilizer material, at least one plasticizer (e.g., a non-blooming plasticizer), at least one curing agent, at least one smoke suppressant and/or char former, at least one flame retardant, at least one filler material, optionally, at least one stabilizer material and optionally at least one second rubber-based material.

The preferred embodiments of the present invention also relate to an olefin based composition or formulation for forming a top coat or top layer for the manufacture of a building component, such as a wall base, the composition comprising at least one olefin-based polymer, at least one plasticizer, at least one compatibilizer, at least one second polymer, at least one temperature stabilizer, at least one flame retardant, at least one smoke suppressant and/or char former, and at least one material for improving durability and aesthetics of the manufactured product.

The composition or formulation of the present invention is totally halogen-free, i.e., includes no halogen in the composition itself. The composition of the present invention is also totally phthalate-free, i.e., includes no phthalates in the composition itself

In general, the formulation in accordance with the preferred embodiments of the present invention may be provided in amounts as follows: (1) back layer formulation: a rubber-based elastomeric material (10-60 phr, preferably 40 phr), an olefinic polymer (25-80 phr, preferably 40 phr), a polymeric plasticizer (0-35 phr, preferably 5 phr), at least one second olefinic polymer which is different from or the same as the first olefinic polymer (0-30 phr, preferably 20 phr), at least one optional additional rubber-based material (0-20 phr, preferably 10 phr), a flame retardant system comprising at least one flame retardant (25-200 phr, preferably 162-175 phr), at least one optional temperature/heat stabilizer (0-10 phr, preferably 0.1 phr), at least one optional reactive polyethylene/curing agents (0-10 phr, preferably 3.75 phr), at least one additional optional reactive polyethylene/curing agent (0-10 phr, preferably 3.75 phr), an optional additional plasticizer (0-25 phr, preferably 15 phr), a smoke suppressant/char former (5-30 phr, preferably 15 phr), resiliency reducer/adhesion promoter (2-10 phr, preferably 7.5 phr), at least one filler material (0-20 phr, preferably 9 phr), at least one additive material (0-50 phr, preferably 21-30 phr), at least one weight reducer (0-10 phr, preferably 3-4 phr), a stabilizer (0-1 phr, preferably 0.25 phr) and at least one lubricant (0-5 phr, preferably 1.5 phr); and (2) top layer formulation: an olefinic polymer (10-40 phr, preferably 20 phr), a second olefinic polymer being the same as or different from the first olefinic polymer (10-40 phr, preferably 25 phr), a polymeric plasticizer (1-25 phr, preferably 15 phr), a compatibilizer (0-25 phr, preferably 3-5 phr), at least one third olefinic polymer being the same as or different from the first and/or second olefinic polymer (0-100 phr, preferably 35 phr), durability promoter (1-10 phr, preferably 4 phr), coloring agents (0-5 phr, preferably 0.8 phr), an optional temperature/heat stabilizer (0-10 phr, preferably 0.1-0.4 phr), a flame retardant system comprising at least one flame retardant (5-50 phr, preferably 31-33 phr), a lubricant (1-7.5 phr, preferably 3-4 phr), a smoke suppressant/char former (1-10 phr, preferably 6-8 phr) and a stabilizer (0-5 phr, preferably 1.0 phr). Other amounts below and above these ranges can be used.

### Formulation for the Back Layer

### First Polymer

The first polymer can be any polymer that is conventionally employed in the formulation for manufacturing flooring or wall base products, so long as the polymer is halogen-free and phthalate-free. The role of the first polymer is to impart elasticity, impact resistance, and/or good processability of the composition used in making the olefin-based elastomeric composition and in a cost-efficient manner, although not limited thereto. According to various embodiments, the first polymer can include, but is not limited to, soft, amorphous polyolefins, polypropylenes/polypropenes or copolymers thereof, and ethylene alpha olefin copolymers or ethylene-octene copolymer. As non-limiting examples, ENGAGE® (Dow), EXACT® (Exxon) or TAFMER® (Mitsui) may be employed in accordance with the present invention. The olefinic polymer may be present in an amount of between 25-80 phr, preferably 40 phr. In a particular embodiment, a polyolefin elastomer under the trade name ENGAGE® 8130 is provided at 40 phr (about 11.26%). Other amounts below and above these ranges can be used.

### First Rubber-Based Material

The first rubber-based elastomeric material can be any elastomeric material that is conventionally employed in the formulation for manufacturing flooring or wall base products, so long as the elastomeric material is halogen-free and phthalate-free. The role of the rubber-based elastomeric material is to reduce the stiffness of the final product, as well as is to impart good elasticity while allowing the product to maintain its shape, such as while being bent around a corner in the case of a wall base product, although not limited thereto. According to various embodiments, the rubber-based elastomeric material can include, but is not limited to, ethylene propylene diene monomer (M-class) rubber (EPDM), styrene-butadiene-rubber (SBR), natural rubber. As non-limiting examples, VISTALON® (Exxon or Kuhmo) (Mitsui) may be employed in accordance with the present invention. The rubber-based elastomeric material may be present in an amount of between 10-60 phr, preferably 40 phr. In a particular preferred embodiment, a rubber-based elastomeric material under the trade name VISTALON® 722 is provided at 40 phr (about 11.26%). Other amounts below and above these ranges can be used.

### Polymeric Plasticizer

The polymeric plasticizer material, in particular a non-blooming plasticizer, can be any polymeric plasticizer material that is conventionally employed in the formulation for manufacturing flooring or wall base products, so long as the polymeric plasticizer material is halogen-free and phthalate-free. The role of the polymeric plasticizer material is to provide a rapidly renewable content to the formulation for manufacturing the back layer, although not limited thereto. According to various embodiments, the polymeric plasticizer material can include, but is not limited to, oil (factus), such as vegetable oil, soy or corn oil. As non-limiting examples, VVO®, a vulcanized vegetable oil, may be employed in accordance with the present invention. The polymeric plasticizer material may be present in an amount of between 0-35 phr, preferably 5 phr. In a particular preferred embodiment, a polymeric plasticizer material available under the trade name ACROFAX® (VVO®) is provided at 5 phr (about 1.41%). Other amounts below and above these ranges can be used.

### Second Polymer

The at least one second polymer can be any polymer that is conventionally employed in the formulation for manufacturing flooring or wall base products, so long as the at least one second polymer is halogen-free and phthalate-free and can be the same as or different from the first polyolefinic polymer. The role of the at least one second polymer is to promote adhesion of the formulation to the acrylic adhesive (discussed below). According to various embodiments, the at least one second polymer can include, but is not limited to, polyolefins, polyethylene, ethylene vinyl acetate (EVA), EVA emulsions, including polyvinyl acetate (PVA,), copolymers based on vinyl acetate (VAM) or vinyl acetate ethylene (VAE), or any other hot melt base adhesives conventional in the art so long as they are halogen-free and phthalate-free. As non-limiting examples, ESCORENE® (Exxon), EVATANE® (Arkema) may be employed in accordance with the preferred embodiments of the present invention. The at least one second olefinic polymer, such as EVA, may be present in an amount of between 0-30 phr, preferably 20 phr. It should be appreciated that other comparable carrier polymers known in the art may be employed in accordance with the present invention at appropriate levels or amounts. In a particular preferred embodiment, an ethylene vinyl acetate available under the trade name ESCORENE® UL 7710 is provided at 20 phr (about 5.63%). Other amounts below and above these ranges can be used.

### At Least One Additional Optional Rubber-Material or Resin/Rosin Material

The at least one additional optional rubber-based material can be any material that is conventionally employed in the formulation for manufacturing flooring or wall base products, so long as the material is halogen-free and phthalate-free. The role of the at least one additional optional rubber-based material is to reduce the rebound of the formulation, although not limited thereto. According to various embodiments, the at least one additional optional rubber-based material can include, but is not limited to, a butyl having the general chemical formula —C₄H₉, including n-butyl, sec-butyl (1-methylpropyl), isobutyl (2-methylpropyl), tert-butyl/t-butyl (1,1-dimethyllethyl) or any isomer thereof being halogen-free and phthalate-free, or alternatively EPDM. As non-limiting examples, butyl 065 (Exxon) or EPDM may be employed in accordance with preferred embodiments of the present invention. Butyl 065 is a copolymer of isobutylene and isoprene having a specific gravity of 0.92. The butyl or EPDM may be present in an amount of between 0-20 phr, preferably 10 phr. In a particular preferred embodiment, butyl 065 (Exxon) or EPDM is provided at 10 phr (about 2.81%). Other amounts below and above these ranges can be used.

In an alternative embodiment, a polyisobutylene or a rosin ester may be employed in appropriate amounts.

### Flame Retardant System

The flame retardant system comprises at least one flame retardant material which is conventionally employed in the formulation for manufacturing flooring or wall base products, so long as the flame retardant material is halogen-free and phthalate-free. The role of the flame retardant material is to provide a flame retardant quality to the formulation for manufacturing the final product in order to meet specific building code and ASTM flame retardant requirements, although not limited thereto. According to various preferred embodiments, the at least one flame retardant material can include, but is not limited to, alumina tri-hydrate, pyrophosphates, magnesium hydroxide, silane or stearic acid-treated or -untreated magnesium hydroxide, melamine cyanurate, melamine polyphosphate, melamine phosphate, mica, or derivatives thereof As non-limiting examples, HYMOD® SB36 (Huber) may be employed as an alumina tri-hydrate in accordance with the present invention, VERTEX®/ZEROGEN® (Akrochem) or, FLOMAG® (Martin Marietta) may be employed as a magnesium hydroxide in accordance with the present invention and MELAPUR® 200 (Ciba) may be employed as a melamine polyphosphate in accordance with the present invention. It should be appreciated that melamine polyphosphate also serves as a char former or intumescent. VERTEX® is a silane or stearic acid-treated magnesium hydroxide having a specific gravity of 2.36. The flame retardant system may be present in an amount of between 25-200 phr, preferably 162-175 phr. In a particular embodiment, an alumina tri-hydrate available under the trade name HYMOD® is provided at 97.5 phr (about 27.20%), a magnesium hydroxide available under the trade name VERTEX provided at 55 phr (about 15.35%) and a melamine polyphosphate available under the trade name MELAPUR ® 200 is provided at 10 phr (about 2.79%). In another preferred embodiment, the entire flame retardant system material comprises alumina tri-hydrate. Other amounts below and above these ranges can be used.

### Temperature/Heat Stabilizer

The at least one optional temperature/heat stabilizer can be any stabilizer material that is conventionally employed in the formulation for manufacturing flooring or wall base products, so long as the material is halogen-free and phthalate-free. The role of the temperature/heat stabilizer is to prevent undesirable excessively high heat or temperature during the processing of the formulation, although not limited thereto. For example, a stabilizer can be added to the composition according to the present invention, to provide heat stability and/or UV light stability to the composition. The stabilizer can be used to minimize degradation and discoloration caused by exposure to heat and light, including conditions encountered in the manufacture of a product containing the composition of the present invention. The stabilizer can be an antioxidant, other stabilizers, or combinations thereof According to various embodiments, the at least one optional temperature/heat stabilizer can include, but is not limited to, a phosphite antioxidant/stabilizer, thiodiethylene bis[3-(3,5-di-tert-butyl-4-hydroxyphenyl)propionate], or derivative thereof being non-halogen and non-phthalate. As non-limiting examples, DOVERPHOS® (Dover), IRGANOX® (Ciba) or TERM-CHEK® (Ferro) may be employed in accordance with the present invention. The one optional temperature/heat stabilizer may be present in an amount of between 0-10 phr, preferably 0.1 phr. In a particular embodiment, DOVERPHOS® S480 is provided at 0.1 phr (about 0.03%). Other amounts below and above these ranges can be used.

### Reactive Curing Agent/Durability Promoter

The at least two optional reactive curing agents can be any reactive curing agent material that is conventionally employed in the formulation for manufacturing flooring or wall base products, so long as the reactive curing agent material is halogen-free and phthalate-free. The role of the reactive curing agent is to facilitate curing of the formulation during processing, although not limited thereto. According to various preferred embodiments, the at least one optional reactive curing agent can include, but is not limited to, a reactive polyethylene, including a reactive polyethylene comprising glycidyl methacrylate (GMA) or maleic anhydride (MAH) groups, peroxides, tert-butyl peroxybenzoate (TBPB), cycloaliphatic epoxides, including cycloaliphatic diepoxide, a high molecular weight polymer, including high molecular weight EPDM or RCP polypropylene. As non-limiting examples, LOTADER® GMA (Arkema), LOTADER® 3430 (MAH) (Arkema), VAROX® (Vanderbilt) or RADCURE® (Radcure) curing agents may be employed in accordance with the present invention. In one preferred embodiment of the present invention, the first optional reactive curing agent is glycidyl methacrylate which may be present in an amount of between 0-10 phr, preferably 3.75 phr and a second optional reactive curing agent is maleic anhydride which may be present in an amount of between 0-10 phr, preferably 3.75 phr. In a particular preferred embodiment, LOTADER® GMA is provided at 3.75 phr and LOTADER® 3430 MAH is provided at 3.75 phr. Other amounts below and above these ranges can be used.

In another preferred embodiment, at least one of a glycidyl methacrylate (GMA) or maleic anhydride (MAH) groups, or peroxides, may be employed as a durability promoter in accordance with preferred embodiments of the present invention. As non-limiting examples, LOTADER® GMA (Arkema), LOTADER® 3430 (MAH) (Arkema) may be employed in accordance with the present invention. In a particular preferred embodiment, LOTADER® AX8840 GMA is provided at 2-10 phr, preferably 3.75 phr and LOTADER® 3430 MAH is provided at 2-10 phr, preferably 3.75 phr. Other amounts below and above these ranges can be used.

In yet another preferred embodiment, a higher molecular weight polymer such as high ethylene EPDM or RCP polypropylene, may be employed in place of the reactive curing agents.

### Additional Optional Plasticizer

The optional additional plasticizer material, in particular a non-blooming plasticizer, can be any plasticizer material that is conventionally employed in the formulation for manufacturing flooring or wall base products, so long as the plasticizer material is halogen-free and phthalate-free. The role of the additional plasticizer material is to provide a rapidly renewable content to the formulation for manufacturing the back layer, although not limited thereto. According to various preferred embodiments, the additional plasticizer material can include, but is not limited to, oils composed of alkanes (15-40 carbons) or cyclic paraffins, such as mineral oil, polymer modifiers, such as hydrocarbon fluids, sun oil, vegetable oil, soy, linseed oil, corn oil or a comparable wax substitute. As a non-limiting example, mineral oil may be employed in accordance with preferred embodiments of the present invention. The mineral oil as an additional plasticizer material may be present in an amount of between 0-25 phr, preferably 15 phr. In a particular preferred embodiment, mineral oil, or a paraffin oil as an additional plasticizer material is provided at 15 phr (about 4.22%). Other amounts below and above these ranges can be used.

### Smoke Suppressant/Char Former

The smoke suppressant/char former, in combination with a synergist which is known in the art, comprises at least one smoke suppressant and/or char former material which is conventionally employed in the formulation for manufacturing flooring or wall base products, so long as the smoke suppressant and/or char former material is halogen-free and phthalate-free. The role of the smoke suppressant/char former material is to provide a smoke suppressing/char forming quality to the formulation for manufacturing the final product in order to meet specific building code and ASTM flame retardant requirements, although not limited thereto. According to various preferred embodiments, the smoke suppressant/char former (or promoter) material (i.e., better resistance against surface cracking) can include, but is not limited to, boron compounds, including zinc borate, boric acid, borax. As non-limiting examples, AZ467 zinc borate may be employed as a smoke suppressant/char former in accordance with the preferred embodiments of the present invention. The AZ467 zinc borate may be present in an amount of between 5-30 phr, preferably 15 phr. In a particular preferred embodiment, AZ467 zinc borate is provided at 15 phr (about 4.22%). Other amounts below and above these ranges can be used.

### Resiliency Reducer/Adhesion Promoter

The resiliency reducer/adhesion promoter material may be any resiliency reducer/adhesion promoter material which is conventionally employed in the formulation for manufacturing flooring or wall base products, so long as the resiliency reducer/adhesion promoter material is halogen-free and phthalate-free. The role of the resiliency reducer/adhesion promoter material is to reduce the resiliency of the manufactured product and to promote the adhesion of the manufactured product to another surface in order to meet specific building code and ASTM requirements, as well as to promote adhesion of the back layer formulation to the top layer formulation, although not limited thereto. In accordance with the preferred embodiments of the present invention, the resiliency reducer/adhesion promoter material comprises a material which has a rapidly renewable content. According to various preferred embodiments, the resiliency reducer/adhesion promoter material can include, but is not limited to, rosins or resins, including, tall oil rosin or resin and esters thereof, pine rosin or resin and esters thereof or any comparable shell extracts. As non-limiting examples, tall oil rosin may be employed as a resiliency reducer/adhesion promoter material in accordance with preferred embodiments of the present invention. The tall oil rosin may be present in an amount of between 2-10 phr, preferably 7.5 phr. In a particular preferred embodiment, tall oil rosin is provided at 7.5 phr (about 2.11%). Other amounts below and above these ranges can be used.

### Filler Material and Additives

The at least one filler material may be any type of rapidly renewable filler material which is conventionally employed in the formulation for manufacturing flooring or wall base products, so long as the filler material is halogen-free and phthalate-free. The role of the filler material is to promote the rapidly renewable content, to reduce cost and improve the quality of the manufactured product, although not limited thereto. In accordance with preferred embodiments of the present invention, the rapidly renewably filler material comprises a plant-based filler material which provides a rapidly renewable content to the manufactured product. According to various preferred embodiments, the at least one filler material can include, but is not limited to, organic, inorganic or combinations of organic and inorganic material, such as walnut shell, flax, oat, paper, ground paper, cloth, cotton, cardboard, wood flower including, tall oil rosin or resin and esters thereof, pine rosin or resin and esters thereof or any comparable shell extracts, oyster shell, calcium carbonate, talc, silicates, meta-silicates, clay, synthetic and natural fiber, or any combination thereof. The filler can be in any physical form, such as particles, that allows it to be mixed or blended with the other components to form the olefin-based composition that can be processed into an olefin-based flooring accessory, such as a wall base. As a non-limiting example, walnut shell may be employed as the at least one filler material in accordance with preferred embodiments of the present invention. The walnut shell may be present in an amount of between 0-20 phr, preferably 9 phr. In a particular preferred embodiment, walnut shell is provided at 9 phr (about 8.44%). Other amounts below and above these ranges can be used.

The additive material may be any type of additive material which is conventionally employed in the formulation for manufacturing flooring or wall base products, so long as the additive material is halogen-free and phthalate-free. The role of the additive material is to increase the recycled content of the formulation for the manufactured product, although not limited thereto. In accordance with preferred embodiments of the present invention, the recyclable additive material comprises a material which provides a recyclable content to the manufactured product. According to various preferred embodiments, the additive material can include, but is not limited to, tall oil rosin or resin and esters thereof, pine rosin or resin and esters thereof or any comparable shell extracts, oyster shell or other comparable shell content, calcium carbonate, talc, silicates. The additive can be in any physical form, such as particles, that allows it to be mixed or blended with the other components to form the olefin-based composition that can be processed into an olefin-based flooring accessory, such as a wall base. As a non-limiting example, calcium carbonate, such as in the form of oyster shell, may be employed as the additive material in accordance with preferred embodiments of the present invention. The calcium carbonate, such as oyster shell, may be present in an amount of between 0-50 phr, preferably 21-30 phr. In a particular preferred embodiment, calcium carbonate, such as oyster shell, is provided at 30 phr (about 8.44%). Other amounts below and above these ranges can be used.

### Weight-Reducing Agent

The at least one weight-reducing agent may be any weight-reducing agent which is conventionally employed in the formulation for manufacturing flooring or wall base products, so long as the weight-reducing agent is halogen-free and phthalate-free. The role of the weight-reducing agent is to reduce the overall weight of the manufactured product without compromising strength, durability, resiliency, flexibility, or aesthetic quality of the manufactured product, although not limited thereto. In accordance with preferred embodiments of the present invention, the at least one weight-reducing agent material may comprise a foaming agent, a chemical blowing agent, hollow glass microspheres having high strength to density ratio (i.e., glass bubbles and treated glass bubbles), and any other comparable organic, inorganic or combinations of organic and inorganic filler or non-flammable lubricants known in the art that are non-halogen and non-phthalate. As non-limiting examples, EXPANCEL® (AkzoNobel) foaming agent may be employed in accordance with an embodiment of the present invention and 3M S38HS glass bubbles may be employed in accordance with the present invention. In one exemplary embodiment of the present invention, a foaming agent may be present in an amount of between 0-10 phr, preferably 0.01 phr and/or glass bubbles may be present in an amount of between 0-10 phr, preferably 3.75 phr (about 1.06%). For example, EXPANCEL 951 DU 120® foaming agent can be provided at 0.01 phr and/or 3M S38HS glass bubbles are provided at 3.75 phr. Other amounts below and above these ranges can be used.

### Stabilizer

A stabilizer material may be any stabilizer material which is conventionally employed in the formulation for manufacturing flooring or wall base products, so long as the stabilizer material is halogen-free and phthalate-free. The role of the stabilizer material is to stabilize the formulation during processing, as known in the art, although not limited thereto. In accordance with preferred embodiments of the present invention, the stabilizer material may be, but not limited to, primary antioxidants, such as tetrakis methylene (3,5-di-t-butyl-4-hydroxy-hydrocinnamate) methane or [3-[3-(3,5-ditert-butyl-4-hydroxyphenyepropanoyloxy]-2,2-bis [3-(3,5-ditert-butyl-4-hydroxyphenyl)propanoyloxymethyl]propyl] 3-(3,5-ditert-butyl-4-hydroxyphenyl)propanoate. As non-limiting examples, DOVERNOX® (Dover) may be employed in accordance with preferred embodiments of the present invention, as well as any comparable stabilizer by Ciba, Songwon or Ferro. In one preferred embodiment of the present invention, the stabilizer may be present in an amount of between 0-1 phr, preferably 0.25 phr. In a particular preferred embodiment, DOVERNOX® 10 stabilizer is provided at 0.25 phr (about 0.07%). Other amounts below and above these ranges can be used.

### Lubricant

The lubricant material, in particular a non-flammable lubricant, can be any lubricant material that is conventionally employed in the formulation for manufacturing flooring or wall base products, so long as the lubricant material is halogen-free and phthalate-free. The role of the lubricant material is to provide a lubricant content to the formulation for manufacturing the back layer to facilitate processing of the formulation, although not limited thereto. According to various preferred embodiments, the lubricant material can include, but is not limited to, any conventional non-flammable lubricant that is devoid of halogens and phthalates, such as free acid organic phosphate esters. As non-limiting examples, VANFRE® Special (Vanderbilt) stabilizer material may be employed in accordance with preferred embodiments of the present invention. In one preferred embodiment of the present invention, the lubricant material is a free acid organic phosphate ester which may be present in an amount of about 0-5 phr. In a particular preferred embodiment, VANFRE® AP-2 SPECIAL is provided at about 1.5 phr (about 0.42%). Other amounts below and above these ranges can be used.

### Formulation for the Top Coat

### First Polymer

The first polymer can be any polymer that is conventionally employed in the formulation for manufacturing flooring or wall base products, so long as the polymer is halogen-free and phthalate-free. The role of the first polymer is to facilitate processing and/or curing of the formulation for the manufacture of the product, as well as providing strength and stiffness quality to the manufactured top coat layer, although not limited thereto. According to various preferred embodiments, the first polymer can include, but is not limited to, soft, amorphous polyolefins, polypropylenes/polypropenes or copolymers thereof, and ethylene alpha olefin copolymers or ethylene-octene copolymer, as well as homopolymer polypropylene, glycidyl methacrylate (GMA) or maleic anhydride (MAH) groups, or peroxides for curing. As non-limiting examples, ENGAGE® (Dow), EXACT® (Exxon), TAFMER® (Mitsui), INOES® (Inoes), LOTADER® GMA (Arkema), or LOTADER® 3430 (MAH) (Arkema) may be employed in accordance with preferred embodiments of the present invention. The olefinic polymer may be present in an amount of between 10-40 phr, preferably 20 phr. In a particular preferred embodiment, a polypropylene available under the trade name INOES® R01c-00 is provided at 20 phr (about 12.65%). Other amounts below and above these ranges can be used.

### Second Polymer

The second polymer can be any polymer that is conventionally employed in the formulation for manufacturing flooring or wall base products and which is the same as or different from the first polymer, so long as the polymer is halogen-free and phthalate-free. The role of the second polymer is to facilitate processing and/or curing of the formulation for the manufacture of the product, as well as reducing stress whitening or stress crystallization of the manufactured top coat layer, although not limited thereto. According to various preferred embodiments, the second polymer can include, but is not limited to, soft, amorphous polyolefins, polypropylenes/polypropenes or copolymers thereof, and ethylene alpha olefin copolymers or ethylene-octene copolymer, as well as homopolymer polypropylene, propylene-based olefinic elastomers, or an appropriate polymeric or monomeric plasticizer material. As non-limiting examples, ENGAGE® (Dow), VISTAMAXX® (Exxon), TAFMER® (Mitsui), INOES® (Inoes) may be employed in accordance with preferred embodiments of the present invention. The olefinic polymer may be present in an amount of between 10-40 phr, preferably 25 phr. In a particular preferred embodiment, a propylene-based olefinic elastomer available under the trade name VISTAMAXX ® 6102 is provided at 25 phr (about 18.81%). Other amounts below and above these ranges can be used.

### Third Polymer

The third polymer can be any polymer that is conventionally employed in the formulation for manufacturing flooring or wall base products and which is the same as or different from the first polymer and/or the second polymer, so long as the polymer is halogen-free and phthalate-free. The role of the third polymer is to facilitate processing and/or curing of the formulation for the manufacture of the product, as well as providing strength and stiffness quality to the manufactured top coat layer, although not limited thereto. In particular, the third polymer according to a preferred embodiment is provided to prevent unwanted excessive tackiness of the second polymer during processing as well as to reduce stiffness of the first polymer (homopolymer) during processing. According to various preferred embodiments, the third polymer can include, but is not limited to, soft, amorphous polyolefins, polypropylenes/polypropenes or copolymers thereof, and ethylene alpha olefin copolymers or ethylene-octene copolymer, as well as homopolymer polypropylene, or a polypropylene in combination with an appropriate amount of a monomeric plasticizer or polymeric plasticizer. As non-limiting examples, ENGAGE^{e} (Dow), EXACT® (Exxon), TAFMER® (Mitsui), INOES® (Inoes), or VERSIFY® (Dow) may be employed in accordance with preferred embodiments of the present invention. The olefinic polymer may be present in an amount of about 35 phr. In a particular preferred embodiment, a propylene-ethylene copolymer available under the trade name VERSIFY® 2300 is provided at 35 phr (about 22.14%). Other amounts below and above these ranges can be used.

### Polymeric Plasticizer

The polymeric plasticizer material, in particular a non-blooming plasticizer, can be any polymeric plasticizer material that is conventionally employed in the formulation for manufacturing flooring or wall base products, so long as the polymeric plasticizer material is halogen-free and phthalate-free. The role of the polymeric plasticizer material is to soften the top coat layer during processing to facilitate the formation of the manufactured product, although not limited thereto. According to various preferred embodiments, the polymeric plasticizer material can include, but is not limited to, soft, amorphous polyolefins, polypropylenes/polypropenes or copolymers thereof, and ethylene alpha olefin copolymers or ethylene-octene copolymer, as well as homopolymer polypropylene, propylene-based olefinic elastomers, or an appropriate polymeric or monomeric plasticizer material, polyethylene, ethylene vinyl acetate (EVA), EVA emulsions, including polyvinyl acetate (PVA_{c}), copolymers based on vinyl acetate (VAM) or vinyl acetate ethylene (VAE), or any other hot melt base adhesives conventional in the art so long as they are halogen-free and phthalate-free. As non-limiting examples, ENGAGE® (Dow), VISTAMAXX® (Exxon), TAFMER® (Mitsui), WOES® (Inoes), ESCORENE® (Exxon), EVATANE® (Arkema) may be employed in accordance with preferred embodiments of the present invention. The polymeric plasticizer material may be present in an amount of between 1-25 phr, preferably 15 phr. In a particular preferred embodiment, a polymeric plasticizer material that is a polyolefin elastomer available under the trade name ENGAGE ® 8130 is provided at 15 phr (about 9.49%). Other amounts below and above these ranges can be used.

### Compatibilizer

The compatibilizer material can be any compatibilizer material that is conventionally employed in the formulation for manufacturing flooring or wall base products, so long as the compatibilizer material is halogen-free and phthalate-free. The role of the compatibilizer material is to bind the flame retardant ingredients in the formulation, although not limited thereto. The compatibilizer is one that also acts as a coupling agent or interfacial bonding agent for a polyolefin matrix and filler such that it also provides good tack in a calendaring process. According to various preferred embodiments, the compatibilizer material can include, but is not limited to, a maleic anhydride, including a high performance maleic anhydride functionalized homo-polypropylene, a nitrile or nitrile rubber, modified ethylene acrylate carbon monoxide terpolymers, ethylene vinyl acetates (EVAs), polyethylenes, metallocene polyethylenes, ethylene propylene rubbers and polypropylenes. As non-limiting examples, EXXELOR® (Exxon), FUSABOND® (DuPont) may be employed in accordance with the present invention. In one preferred embodiment of the present invention, the compatibilizer material is a high performance maleic anhydride functionalized homo-polypropylene which may be present in an amount of between 0-25 phr, preferably 3-5 phr. In a particular preferred embodiment, a high performance maleic anhydride functionalized homo-polypropylene available under the trade name EXXELOR ® PO 1020 is provided at 3-5 phr (about 1.89%). Other amounts below and above these ranges can be used.

### Flame Retardant System

The flame retardant system comprises at least one flame retardant material which is conventionally employed in the formulation for manufacturing flooring or wall base products, so long as the at least one flame retardant material is halogen-free and phthalate-free. The role of the at least one flame retardant material is to provide a flame retardant quality to the formulation for manufacturing the final product in order to meet specific building code and ASTM flame retardant requirements, although not limited thereto. According to various preferred embodiments, the at least one flame retardant material can include, but is not limited to, alumina tri-hydrate, aluminum trihydroxide, pyrophosphates, magnesium hydroxide, silane or stearic acid-treated magnesium hydroxides, melamine cyanurate, melamine polyphosphate, melamine phosphate, mica, or derivatives thereof. As non-limiting examples, HYMOD® SB36 (Huber) may be employed as an alumina tri-hydrate in accordance with preferred embodiments of the present invention, VERTEX®/ZEROGEN® (Akrochem), ATH® (Henan) or FLOMAG® (Martin Marietta) may be employed as a magnesium hydroxide in accordance with preferred embodiments of the present invention and MELAPUR® 200 (Ciba) may be employed as a melamine polyphosphate in accordance with preferred embodiments of the present invention. It should be appreciated that melamine polyphosphate also serves as a char former or intumescent. VERTEX® is a silane or stearic acid-treated or -untreated magnesium hydroxide having a specific gravity of 2.36. The flame retardant system may be present in an amount of between 5-50 phr, preferably 31-33 phr. In a particular preferred embodiment, a melamine polyphosphate available under the trade name MELAPUR ® 200 is provided at 10 phr (about 7%) and a magnesium hydroxide available under the trade name VERTEX® is provided at 22.5 phr (about 14.23%). Other amounts below and above these ranges can be used.

### Temperature/Heat Stabilizer

The at least one optional temperature/heat stabilizer can be any stabilizer material that is conventionally employed in the formulation for manufacturing flooring or wall base products, so long as the material is halogen-free and phthalate-free. The role of the temperature/heat stabilizer is to prevent undesirable excessively high heat or temperature during the processing of the formulation, although not limited thereto. According to various preferred embodiments, the at least one optional temperature/heat stabilizer can include, but is not limited to, a phosphite antioxidant/stabilizer, thiodiethylene bis[3-(3,5-di-tert-butyl-4-hydroxyphenyl)propionate], or derivative thereof being non-halogen and non-phthalate. As non-limiting examples, DOVERPHOS® (Dover), IRGANOX® (Ciba) or TERM-CHEK® (Ferro) may be employed in accordance with preferred embodiments of the present invention. The one optional temperature/heat stabilizer may be present in an amount of between 0-10 phr, preferably 0.1 phr. In a particular preferred embodiment, a temperature/heat stabilizer available under the trade name DOVERPHOS® S480 is provided at 0.4 phr (about 0.25%). Other amounts below and above these ranges can be used.

### Durability Promoter

The surface durability promoter material can be any durability promoter material that is conventionally employed in the formulation for manufacturing flooring or wall base products, so long as the durability promoter material is halogen-free and phthalate-free. The role of the durability promoter material is to provide a resistance coating to the top coat layer of the manufactured product, such as to promote chemical resistance, scratch resistance, although not limited thereto. According to various preferred embodiments, the durability promoter material can include, but is not limited to, functionally modified polyolefins, a hydrophilic internal additive or a silicone-based surface durability promoter, such as a siloxane additive. As non-limiting examples, a durability promoter material available under the trade names IRGASURF® (Ciba), ADMER® (Mitsui), Clariant or Multibatch Dow Corning® MB50-001 Masterbatch (a pelletized formulation containing 50% of an ultra-high molecular weight siloxane polymer dispersed in polypropylene (PP) homopolymer) may be employed in accordance with preferred embodiments of the present invention in an amount of between 1-10 phr, preferably 4 phr. In a particular preferred embodiment, a durability promoter material available under the trade name Multibatch Dow Corning® MB50-001 Masterbatch is provided at 4 phr (about 2.53%). Other amounts below and above these ranges can be used.

### Smoke Suppressant/Char Former

The smoke suppressant/char former comprises at least one smoke suppressant and/or char former material which is conventionally employed in the formulation for manufacturing flooring or wall base products, so long as the smoke suppressant and/or char former material is halogen-free and phthalate-free. The role of the smoke suppressant/char former material is to provide a smoke suppressing/char forming quality to the formulation for manufacturing the final product in order to meet specific building code and ASTM flame retardant requirements, although not limited thereto. According to various preferred embodiments, the smoke suppressant/char former or promoter material (i.e., better resistance against surface cracking) can include, but is not limited to, boron compounds, including zinc borate, boric acid, borax. As non-limiting examples, AZ467 zinc borate may be employed as a smoke suppressant/char former in accordance with preferred embodiments of the present invention. The AZ467 zinc borate may be present in an amount of between 1-10 phr, preferably 6-8 phr. In a particular preferred embodiment, AZ467 zinc borate is provided at 7.5 phr (about 4.74%). Other amounts below and above these ranges can be used.

### Coloring Material

The at least one optional coloring material may be included which is conventionally employed in the formulation for manufacturing flooring or wall base products, so long as the coloring material is halogen-free and phthalate-free. The role of the coloring material is to provide an aesthetic color quality to the manufactured product, although not limited thereto. In accordance with preferred embodiments of the present invention, the coloring material comprises a polyolefin carrier system with non-heavy metal pigments. According to various preferred embodiments, the coloring material may be present in an amount of between 0-5 phr, preferably 0.8 phr. In a particular preferred embodiment, the coloring material is provided at 0.8 phr (i.e., about in a range between 1/3% to about 5% by weight). Other amounts below and above these ranges can be used. For example, pure color pigment (such as from Ciba, Sheperd or Lanxes) may be employed in an amount as low as 0.3 phr.

### Stabilizer

A stabilizer material may be any stabilizer material which is conventionally employed in the formulation for manufacturing flooring or wall base products, so long as the stabilizer material is halogen-free and phthalate-free. The role of the stabilizer material is to stabilize the formulation during processing, as known in the art, although not limited thereto. In accordance with preferred embodiments of the present invention, the stabilizer material may be, but not limited to, primary antioxidants, such as tetrakis methylene (3,5-di-t-butyl-4-hydroxy-hydrocinnamate) methane or [3-[3-(3,5-ditert-butyl-4-hydroxyphenyl)propanoyloxy]-2,2-bis[3-(3,5-ditert-butyl-4-hydroxyphenyl)propanoyloxymethyl]propyl] 3-(3,5-ditert-butyl-4-hydroxyphenyl)propanoate. As non-limiting examples, DOVERNOX® (Dover) may be employed in accordance with preferred embodiments of the present invention, as well as any comparable stabilizer by Ciba, Songwon or Ferro. In one preferred embodiment of the present invention, the stabilizer may be present in an amount of between 0-5 phr, preferably 1.0 phr. In a particular preferred embodiment, DOVERNOX® 10 stabilizer is provided at 1.0 phr (about 0.6%). Other amounts below and above these ranges can be used.

### Lubricant

The lubricant material, in particular a non-flammable lubricant, can be any lubricant material that is conventionally employed in the formulation for manufacturing flooring or wall base products, so long as the lubricant material is halogen-free and phthalate-free. The role of the lubricant material is to provide a lubricant content to the formulation for manufacturing the back layer to facilitate processing of the formulation, although not limited thereto. According to various preferred embodiments, the lubricant material can include, but is not limited to, any conventional non-flammable lubricant that is devoid of halogens and phthalates, such as free acid organic phosphate esters. As non-limiting examples, VANFRE® Special (Vanderbilt) processing material may be employed in accordance with preferred embodiments of the present invention. In one preferred embodiment of the present invention, the lubricant material is a free acid organic phosphate ester which may be present in an amount of about 1-7.5 phr, preferably 3-4 phr. In a particular preferred embodiment, VANFRE® AP-2 SPECIAL is provided at 3.75 phr (about 2.37%). Other amounts below and above these ranges can be used.

The olefin based composition in accordance with the present invention can be made by any conventional method for the manufacture of flooring accessories, such as a wall base. The olefin-based composition can be processed by numerous methods known in the art including, for example but not limited to, sheet extrusion, thermoforming, injection molding, calendering, profile extrusion, blow molding, and casting. For example, the olefin based composition can be made by mixing the components of the composition or extruding the composition in a twin screw, a single screw, a Banbury mixer, an extruder with a slot die or roller die, or any combination thereof to form a blend. The composition can be processed by processing the particular ingredients employed therein at a temperature close to or above the melting point of the ingredients.

### EXAMPLES

The following examples are intended to illustrate the present invention, in particular for the manufacture of a wall base by way of conventional manufacturing methods. The invention is illustrated by the following Examples, in which parts are proportions by weight unless otherwise specified.

### Example 1

### General Formulation

| | | Wall base |
|---|---|---|
| | | formulation |
| Material description | Material Example | (parts) |
| EPDM | NORDEL ® | 10-33 |
| Olefinic plastic | ENGAGE ® | 25-80 |
| Polymeric vegetable | FACTUS ® | 0-35 |
| plasticizer | | |
| Color (if necessary) | Ultramarine blue | 0-1 |
| Compatibilizer/ | EXXALOR ® | 0-25 |
| tear strength | | |
| improver | | |
| Renewable filler | Oyster shell/walnut shell | 0-100 |
| Curing agent | LOTADER ® | 0-10 |
| Plasticizer | Paraffin/mineral oil | 0-25 |
| Flame retardant | VERSIFY ®/ALUMINA ® | 25-150 |
| Adhesion promoter | ELAVAX ® | 10-20 |
| Adhesive | Pine rosin | 2-10 |
| Char former | MELAPUR ® | 5-20 |
| Smoke suppressant | Zinc borate | 5-30 |
| Weight reducers | Glass bubbles | 0.05-3 |
| | and/or EXPANCEL ® | |

### Example 2

Top Coat:

| 93B1 | MATERIAL | PHR | % | Batch |
|---|---|---|---|---|
| 1 | INNOES ® R01c-00 | 20 | 12.65182 | 34.79 |
| 1 | VISTAMAXX6102 | 25 | 15.81478 | 43.49 |
| 1 | ENGAGE ® 8130 | 15 | 9.488866 | 26.09 |
| 1 | EXXALOR ® 1020 | 3 | 1.897773 | 5.22 |
| | VERSIFY ® 2300 | 35 | 22.14069 | 60.89 |
| | Multibatch Dow | 4 | 2.530364 | 6.96 |
| | Corning ® MB50- | | | |
| | 001 Masterbatch | | | |
| 1 | color | 0.8 | 0.506073 | 1.39 |
| 1 | DOVERPHOS ® | 0.4 | 0.253036 | 0.70 |
| | S420 | | | |
| | | | 0 | 0.00 |
| 4 | ATH ® SB 36 | 20 | 12.65182 | 34.79 |
| | | | 0 | 0.00 |
| 2 | VERTEX ® 60 or | 22.5 | 14.2333 | 39.14 |
| | 90SV | | | |
| | | | 0 | 0.00 |
| 3 | VANFRE ® AP2 | 3.75 | 2.372217 | 6.52 |
| | Special | | | |
| 3 | Zinc Borate AZ467 | 7.5 | 4.744433 | 13.05 |
| | | | 0 | 0.00 |
| 3 | DOVERNOX ® 10 | 0.5 | 0.316296 | 0.87 |
| | | 0 | 0 | 0.00 |
| | | 158.08 | 100 | 275.00 |

Back Layer:

| 97D | | | |
|---|---|---|---|
| Non-halogenated 50% | | | |
| Rubber Backlayer | | | |
| Material | PHR | % | Pounds |
| ENGAGE ® 8130/- | 40 | 11.16% | 66.74107143 |
| TAFMER ® | | | |
| VISTALON ® 722 | 40 | 11.16% | 66.74107143 |
| Butyl 065/EPDM | 10 | 2.79% | 16.68526786 |
| ESCORENE ® UL 7710 | 20 | 5.58% | 33.37053571 |
| Alumina SB36 | 97.5 | 27.20% | 162.6813616 |
| DOVERPHOS ® S480 | 0.1 | 0.03% | 0.166852679 |
| Oil (Factus) | 5 | 1.40% | 8.342633929 |
| Lotader GMA | 3.75 | 1.05% | 6.256975446 |
| LOTADER ® 3430 (MAH) | 3.75 | 1.05% | 6.256975446 |
| VERTEX ® (MgOH) | 55 | 15.35% | 91.76897321 |
| mineral oil | 15 | 4.19% | 25.02790179 |
| AZ467 Zinc Borate | 15 | 4.19% | 25.02790179 |
| walnut shell | 9 | 2.51% | 15.01674107 |
| tall oil rosin | 7.5 | 2.09% | 12.51395089 |
| oyster shell | 21 | 5.86% | 35.0390625 |
| bubbles | 3.75 | 1.05% | 6.256975446 |
| VANFRE ® AP2 Special | 1.5 | 0.42% | 2.502790179 |
| DOVERNOX ® 10 | 0.25 | 0.07% | 0.417131696 |
| MELAPUR ® 200 | 10 | 2.79% | 16.68526786 |
| total | 358.4 | 100.00% | 598 |
| Check weight | | | 598 |
| FR's | | 52.33% | |
| Inorganics | | 57.03% | |

The embodiment as shown in Example 2 runs easily in a roller die or a slot die or into roll stack processing methods and also passes flaming, smoldering and adhesion tests in accordance with building code specification and ASTM requirements. The embodiment as shown in Example 2 also mixes easily in a Banbury mixer.

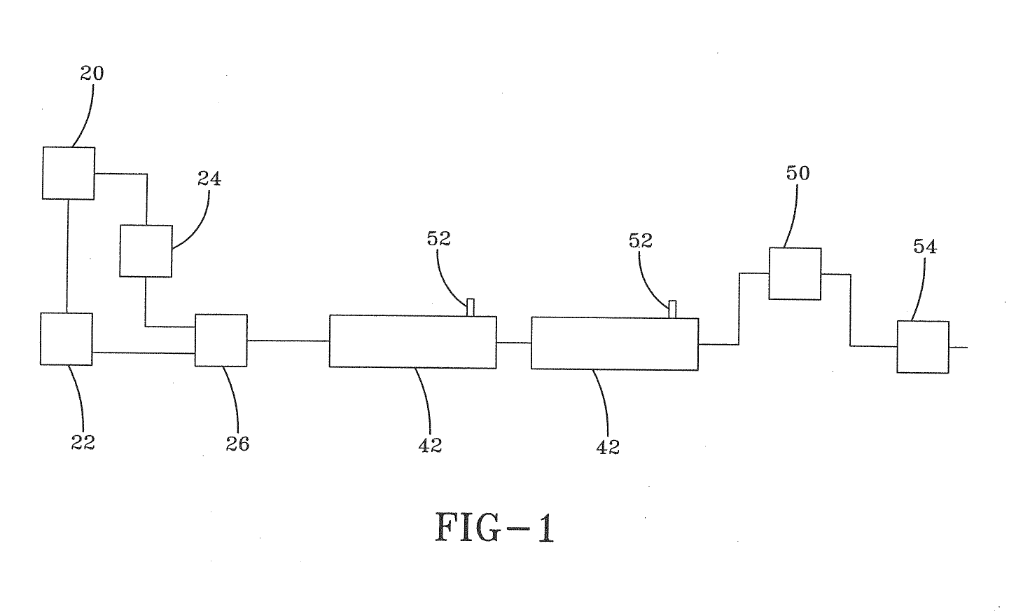

The formulation of the present invention can be made by known conventional processes for manufacturing a wall base, or other building accessory, formulation. The wall base can be manufactured relatively quickly, easily and economically by known conventional processes. The wall base is made from a composition, as described supra, being suitable for extrusion. Referring to FIG. 1, the raw materials are supplied to the extruders from a conventional supply unit 20. The composition is extruded from two separate extruders, a main extruder 22, and a side extruder 24 as shown in FIG. 1. Extruders 22, 24 can be standard extruders known in the art for manufacturing wall bases. The main extruder 22 heats the raw material to put it into an extrudable state and extrudes through appropriate dies a back layer material which makes up about 90% of the finished wall base, including the front wall having the profile of the wall base. The side extruder 24 likewise heats the raw material to a fluid state and extrudes it through appropriate dies to yield a thin top coat layer, preferably having a thickness of about up to 0.010″ to 0.012″ of very high quality material for a wall base having a height of up to about 6 inches and a thickness of up to about ¼ inch. This is referred to as high quality material because it is a highly pigmented, no filler top coat. This very high quality material represents about 10% of the finished wall base material used. The softened plastic flow during extrusion does not cool sufficiently to impede further flow through the respective dies and along the extrusion production line. In the demonstrated exemplary process, a multiple piece die 26 shown downstream of extruders 22, 24 stays hotter and thus the formulation flows quickly to reduce production time. The multiple piece die 26 is comprised of multiple machined parts that allow semi molten material to flow from the die. The extrusion material is forced through the die by the force generated by the extruder. As the material passes through the die 26, it is formed into the shape of the wall base.

The die 26 establishes the profile of the wall base by defining the shape of the front wall and rear wall. In an exemplary embodiment, the wall base is ⅛ inch thick at the widest point and is 6 inches tall. The rear wall can have ribs, grooves, a mixture thereof or other surface roughness on its exterior face to which adhesive could be applied during installation which would impede the flow of adhesive from rear wall.

The generally uniform wall thickness provides a fairly constant thickness for uniform cooling. However, the temperature must be low enough to prevent sagging under its own weight. Uniform cooling is required to obtain a smooth, finished look and profile of the wall base.

The process used to create the wall base may be as follows. The composition in accordance with the present invention flows or is otherwise transported into both the main extruder 22 and the side extruder 24 which both feed into the multiple piece die 26. As described above, the wall base back layer flows from main extruder 22 and top coat layer flows from side extruder 24. The outer side or profile of the front wall of the wall base is formed by the profile cut into or otherwise provided in the die 26.

The main extruder 22 can be a 6 inch Thermatic Davis Standard. The side extruder 24 can be a 2.5 inch Davis Standard. The die 26 can form the wall base with one of various profiles such as a wedge-shaped base with a lip at the bottom, an undulating profile on a flat surface or the like. A separate die is used for each style of profile.

Within the die 26, as shown in FIG. 1, the extruded solid plastic is formed into the desired profile. Material flows through die 26, and it takes from between 1 and 2 seconds for the material to enter and leave die 26. The temperature in the die can be between 300° F. and 325° F.

The wall base back layer material and thin top coat layer are completely fused together in die 26, creating a fluid plastic material, through a combination of pressure created by the movement of material through the extruders and the resistance of that material moving through the restrictive opening in the die and the internal heat at a temperature of about 325° F. of the wall base material. This generates a maximum pressure of about 3000 psi within the die.

The wall base material is pushed through and out of the die 26 under the pressures created by the extruders 22 and 24. From the die 26, the wall base is initially manually pulled the length of the two cooling tanks by the extruder operator until the material reaches the mechanical or power puller 50. Each of the tanks 42, which can be either a 30 foot (9 meter) or 40 foot (12 meter) trough, has at least one faucet 52. The tank can be on wheels enabling it to move towards and away from the die 26. The bath has chilled water with a temperature range of 50° F. to 60° F. (10° C. to 16° C.), to cool the extruded flexible wall base whose temperature upon entering the bath exceeds 300° F. (150° C.).

After emerging from the cooling tanks 42, the wall base is engaged by mechanical or powered puller 50. The puller 50, which can be a Goodman, is maintained at a constant speed which can range from 15 to 20 FPM to ensure consistent size of the extruded wall base as it is pulled from the die 26. The extruded wall base then passes into a cutter 54 and is cut to a pre-determined or desired length. The wall base is normally cut at a length of eight feet, but can be cut at any length, and proper packaging should be made available. The temperature of the extruders 22, 24, which can range from 275° F. to 350° F., the machine speed settings, which range from 20 RPM to 40 RPM on the extruders, and the powered puller's 50 speed settings control the size or thickness of the wall base. These settings must be fixed initially and monitored to assure size consistency. Once operating speeds and part size are established, the wall base is cut and packaged for shipment.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A composition or formulation for manufacturing a flooring accessory, said composition comprising a first formulation and a second formulation that are cured together by a partial cure to form said composition, wherein said composition is devoid of halogens and devoid of phthalates, wherein said first formulation comprises a rubber-based elastomeric material in an amount of 10-60 phr, a first olefinic polymer in an amount of 25-80 phr, a polymeric plasticizer in an amount of 0-35 phr, at least one second olefinic polymer which is different from or the same as said first olefinic polymer provided in an amount of 0-30 phr, a flame retardant system comprising at least one flame retardant material, said flame retardant system provided in an amount of 25-200 phr, a smoke suppressant/char former material provided in an amount of 5-30 phr, and a resiliency reducer/adhesion promoter provided in an amount of 2-10 phr; and wherein said second formulation comprises a first olefinic polymer in an amount of 10-40 phr, a second olefinic polymer being the same as or different from the first olefinic polymer in an amount of 10-40 phr, a polymeric plasticizer in an amount of 1-25 phr, a compatibilizer in an amount of 0-25 phr, at least one third olefinic polymer being the same as or different from the first and/or second olefinic polymer in an amount of 0-100 phr, a durability promoter in an amount of 1-10 phr, a flame retardant system comprising at least one flame retardant material in an amount of 5-50 phr, a smoke suppressant/char former material in an amount of 1-10 phr and a stabilizer in an amount of 0-5 phr.

2. The composition according to claim 1, wherein said first formulation further comprises at least one additional rubber-based material in an amount of 0-20 phr, at least one temperature/heat stabilizer in an amount of 0-10 phr, at least two reactive curing agents in an amount of 0-20 phr, at least one filler material in an amount of 0-20 phr, at least one additive in an amount of 0-50 phr, at least one weight reducer material in an amount of 0-10 phr, a stabilizer in an amount of 0-1 phr, at least one lubricant in an amount of 0-5 phr and an additional plasticizer in an amount of 0-25 phr.

3. The composition according to claim 1, wherein said second formulation further comprises coloring agents in an amount of 0-5 phr, at least one lubricant in an amount of 1-7.5 phr and a temperature stabilizer in an amount of 0-10 phr.

4. The composition according to claim 1, wherein said flooring accessory is a wall base comprising a top coat layer and a back coat layer, and wherein said first formulation forms said back coat layer of said floor accessory and said second formulation forms said top coat layer of said flooring accessory.

5. The composition according to claim 1, wherein said rubber-based elastomeric material of said first formulation is provided in an amount of about 40 phr.

6. The composition according to claim 1, wherein said rubber-based elastomeric material is selected from the group consisting of ethylene propylene diene monomer, ethylene propylene diene monomer (M-class) rubber, styrene-butadiene-rubber, ethylene-propylene copolymers and natural rubber.

7. The composition according to claim 1, wherein said first olefinic polymer of said first formulation is provided in an amount of about 40 phr.

8. The composition according to claim 1, wherein said first olefinic polymer is selected from the group consisting of soft, amorphous polyolefins, polypropylenes/polypropenes or copolymers thereof, ethylene alpha olefin copolymers, ethylene-octene copolymers and ultra-low density ethylene-octene copolymers.

9. The composition according to claim 1, wherein said polymeric plasticizer of said first formulation is provided in an amount of about 5 phr.

10. The composition according to claim 1, wherein said polymeric plasticizer is a non-blooming plasticizer.

11. The composition according to claim 10, wherein said polymeric plasticizer is selected from the group consisting of oils (factus).

12. The composition according to claim 11, wherein said oils are selected from the group of oils consisting of vegetable oil, soy, corn oil and vulcanized vegetable oil.

13. The composition according to claim 1, wherein said at least one second olefinic polymer of said first formulation is provided in amount of about 20 phr.

14. The composition according to claim 1, wherein said at least one second olefinic polymer is selected from the group consisting of polyolefins, polyethylene, ethylene vinyl acetate (EVA), EVA emulsions, polyvinyl acetate (PVA_{c}), copolymers based on vinyl acetate (VAM), vinyl acetate ethylene (VAE), and hot melt base adhesives.

15. The composition according to claim 1, wherein said flame retardant system of said first formulation is provided in an amount of about 162-175 phr.

16. The composition according to claim 1, wherein said flame retardant system comprises at least one material selected from the group consisting of alumina tri-hydrate, pyrophosphates, magnesium hydroxide, silane, stearic acid-treated or -untreated magnesium hydroxide, melamine cyanurate, melamine polyphosphate, melamine phosphate, mica, and derivatives thereof.

17. The composition according to claim 16, wherein said flame retardant system comprises alumina tri-hydrate provided at 97.5 phr, magnesium hydroxide provided at 55 phr and melamine polyphosphate provided at 10 phr.

18. The composition according to claim 16, wherein said flame retardant system consists of alumina tri-hydrate.

19. The composition according to claim 1, wherein said smoke suppressant/char former of said first formulation is provided in combination with a synergist.

20. The composition according to claim 1, wherein said smoke suppressant/char former of said first formulation comprises at least one smoke suppressant material and/or char former material.

21. The composition according to claim 1, wherein said smoke suppressant/char former of said first formulation is provided in an amount of 15 phr.

22. The composition according to claim 1, wherein said smoke suppressant/char former is selected from the group consisting of boron compounds, zinc borate, boric acid and borax.

23. The composition according to claim 1, wherein said resiliency reducer/adhesion promoter is provided is an amount of 7.5 phr.

24. The composition according to claim 1, wherein said resiliency reducer/adhesion promoter comprises a material having a rapidly renewable content.

25. The composition according to claim 24, wherein said resiliency reducer/adhesion promoter comprises a material selected from the group consisting of rosins and resins.

26. The composition according to claim 25, wherein said resiliency reducer/adhesion promoter is selected from the group of rosins and resins consisting of tall oil rosin, tall oil resin, esters of tall oil rosin, esters of tall oil resin, pine rosin, pine resin, esters of pine rosin, esters of pine resin, and shell extracts comparable to the foregoing.

27. The composition according to claim 26, wherein said resiliency reducer/adhesion promoter is tall oil rosin.

28. The composition according to claim 1, wherein said stabilizer is provided in an amount of about 0.25 phr.

29. The composition according to claim 1, wherein said stabilizer is selected from the group consisting of primary antioxidants.

30. The composition according to claim 29, wherein said stabilizer is selected from the group consisting of tetrakis methylene (3,5-di-t-butyl-4-hydroxy-hydrocinnamate) methane and [3-[3-(3,5-ditert-butyl-4-hydroxyphenyl)propanoyloxy]-2,2-bis[3-(3,5-ditert-butyl-4-hydroxy-phenyl)propanoyloxymethyl]propyl] 3-(3,5-ditert-butyl-4-hydroxyphenyl)propanoate.

31. The composition according to claim 2, wherein said at least one temperature/heat stabilizer is provided in an amount of about 0.1 phr.

32. The composition according to claim 2, wherein said at least one temperature/heat stabilizer comprises an antioxidant.

33. The composition according to claim 2, wherein said at least one temperature/heat stabilizer is selected from the group consisting of a phosphite antioxidant/stabilizer, thiodiethylene bis[3-(3,5-di-tert-butyl-4-hydroxyphenyl)propionate], and derivatives of the foregoing.

34. The composition according to claim 2, wherein said at least one lubricant is provided in an amount of about 1.5 phr.

35. The composition according to claim 2, wherein said at least one lubricant is a non-flammable lubricant.

36. The composition according to claim 35, wherein said at least one lubricant is a free acid organic phosphate ester.

37. The composition according to claim 2, wherein said at least one weight-reducing agent is selected from the group consisting of a foaming agent, a chemical blowing agent and hollow glass microspheres having high strength to density ratio.

38. The composition according to claim 37, wherein said hollow glass microspheres are selected from the group consisting of glass bubbles and treated glass bubbles.

39. The composition according to claim 2, wherein said at least one weight-reducing agent comprises at least one material selected from the group consisting of a foaming agent in an amount of between 0-10 phr and glass bubbles in an amount between 0-10 phr.

40. The composition according to claim 39, wherein said at least one weight-reducing agent comprises at least one material selected from the group consisting of a foaming agent provided in an amount of about 0.1 phr and glass bubbles provided in an amount of about 3.75 phr.

41. The composition according to claim 2, wherein said at least one filler material comprises a material having a rapidly renewable content.

42. The composition according to claim 2, wherein said at least one filler material comprises a plant-based filler material having a rapidly renewable content.

43. The composition according to claim 2, wherein said at least one filler material is selected from the group consisting of organic, inorganic and combinations of organic and inorganic plant-based filler material.

44. The composition according to claim 43, wherein said at least one filler material is selected from the group consisting of walnut shell, flax, oat, paper, ground paper, cloth, cotton, cardboard, wood flower, tall oil rosin, tall oil resin, esters of tall oil rosin, esters of tall oil resin, pine rosin, pine resin, esters of pine rosin, esters of pine resin, and comparable shell extracts of the foregoing, oyster shell, calcium carbonate, talc, silicates, meta-silicates, clay, synthetic fiber, natural fiber, and any combination of the foregoing.

45. The composition according to claim 2, wherein said at least one filler material is walnut shell provided in an amount of about 9 phr.

46. The composition according to claim 2, wherein said at least one additive is provided in an amount of about between 21-30 phr.

47. The composition according to claim 2, wherein said at least one additive comprises a recyclable additive material for providing a recyclable content to said composition.

48. The composition according to claim 2, wherein said at least one additive is selected from the group consisting of tall oil rosin, tall oil resin, esters of tall oil rosin, esters of tall oil resin, pine rosin, pine resin, esters of pine rosin, esters of pine resin, oyster shell, calcium carbonate, talc and silicates.

49. The composition according to claim 1, wherein said first olefinic polymer of said second formulation is provided in amount of about 20 phr.

50. The composition according to claim 1, wherein said first olefinic polymer of said second formulation is selected from the group consisting of soft, amorphous polyolefins, polypropylenes/polypropenes or copolymers thereof, and ethylene alpha olefin copolymers, ethylene-octene copolymers, homopolymer polypropylene, glycidyl methacrylate (GMA) or maleic anhydride (MAH) groups, and peroxides.

51. The composition according to claim 50, wherein said first olefinic polymer comprises polypropylene.

52. The composition according to claim 1, wherein said second olefinic polymer of said second formulation is provided in an amount of about 25 phr.

53. The composition according to claim 1, wherein said second olefinic polymer of said second formulation comprises a material being devoid of halogens and phthalates and is the same as or different from said first olefinic polymer of said second formulation.

54. The composition according to claim 1, wherein said second olefinic polymer is selected from the group consisting of soft, amorphous polyolefins, polypropylenes/polypropenes or copolymers thereof, ethylene alpha olefin copolymers, ethylene-octene copolymer, homopolymer polypropylene, propylene-based olefinic elastomers, and a polymeric or monomeric plasticizer material.

55. The composition according to claim 1, wherein said at least one third olefinic polymer of said second formulation is provided in an amount of about 35 phr.

56. The composition according to claim 1, wherein said at least one third olefinic polymer of said second formulation comprises a material being devoid of halogens and phthalates and is the same as or different from said first olefinic polymer of said second formulation and said second olefinic polymer of said second formulation.

57. The composition according to claim 56 wherein said at least one third olefinic polymer is selected from the group consisting of soft, amorphous polyolefins, polypropylenes/polypropenes or copolymers thereof, ethylene alpha olefin copolymers, ethylene-octene copolymer, homopolymer polypropylene, and a polypropylene in combination with a monomeric plasticizer or polymeric plasticizer.

58. The composition according to claim 57, wherein said at least one third olefinic polymer is propylene-ethylene copolymer.

59. The composition according to claim 1, wherein said polymeric plasticizer material of said second formulation is a non-blooming plasticizer.

60. The composition according to claim 1, wherein said polymeric plasticizer material of said second formulation is provided in an amount of about 15 phr.

61. The composition according to claim 1, wherein said polymeric plasticizer material of said second formulation is selected from the group consisting of soft, amorphous polyolefins, polypropylenes/polypropenes or copolymers thereof, ethylene alpha olefin copolymers, ethylene-octene copolymer, homopolymer polypropylene, propylene-based olefinic elastomers, a polymeric or monomeric plasticizer material, polyethylene, ethylene vinyl acetate (EVA), EVA emulsions, polyvinyl acetate (PVA_{c}), copolymers based on vinyl acetate (VAM) or vinyl acetate ethylene (VAE), and hot melt base adhesives.

62. The composition according to claim 61, wherein said polymeric plasticizer material is a polyolefin elastomer.

63. The composition according to claim 1, wherein said compatibilizer material of said second formulation is provided in an amount of about 3-5 phr.

64. The composition according to claim 1, wherein said compatibilizer material of said second formulation is selected from the group consisting of a maleic anhydride, a high performance maleic anhydride functionalized homo-polypropylene, a nitrile, a nitrile rubber, modified ethylene acrylate carbon monoxide terpolymers, ethylene vinyl acetates (EVAs), polyethylenes, metallocene polyethylenes, ethylene propylene rubbers and polypropylenes.

65. The composition according to claim 64, wherein said compatibilizer material is a high performance maleic anhydride functionalized homo-polypropylene.

66. The composition according to claim 1, wherein said flame retardant system of said second formulation comprises at least one flame retardant material.

67. The composition according to claim 1, wherein said at least one flame retardant material is provided in an amount of about 31-33 phr.

68. The composition according to claim 1, wherein said at least one flame retardant material of said second formulation is selected from the group consisting of alumina tri-hydrate, aluminum trihydroxide, pyrophosphates, magnesium hydroxide, silane or stearic acid-treated magnesium hydroxides, melamine cyanurate, melamine polyphosphate, melamine phosphate, mica, and derivatives of the foregoing.

69. The composition according to claim 68, wherein said at least one flame retardant material comprises melamine polyphosphate in an amount of about 10 phr and magnesium hydroxide at about 22.5 phr.

70. The composition according to claim 1, wherein said surface durability promoter of said second formulation is provided in an amount of about 4 phr.

71. The composition according to claim 1, wherein said surface durability promoter of said second formulation is selected from the group consisting of functionally modified polyolefins, hydrophilic internal additives and a siloxane additive.

72. The composition according to claim 1, wherein said smoke suppressant/char former of said second formulation is provided in an amount of about 6-8 phr.

73. The composition according to claim 72 wherein said smoke suppressant/char former is provided in an amount of about 7.5 phr

74. The composition according to claim 1, wherein said smoke suppressant/char former of said second formulation is a material selected from the group consisting of boron compounds.

75. The composition according to claim 74, wherein said boron compound is selected from the group consisting of zinc borate, boric acid and borax.

76. The composition according to claim 1, wherein said stabilizer material of said second formulation is provided in an amount of about 1.0 phr.

77. The composition according to claim 1, wherein said stabilizer material of said second formulation is selected from the group consisting of primary antioxidants.

78. The composition according to claim 77, wherein said primary antioxidants are selected from the group consisting of tetrakis methylene (3,5-di-t-butyl-4-hydroxy-hydrocinnamate) methane and [3-[3-(3,5-ditert-butyl-4-hydroxyphenyl)propanoyloxy]-2,2-bis[3-3,5-ditert-butyl-4-hydroxyphenyl)propanoyloxymethyl]propyl] 3-(3,5-ditert-butyl-4-hydroxyphenyl)propanoate.

79. The composition according to claim 2, wherein said at least one additional rubber-based material is selected from the group consisting of EPDM, a butyl having the general chemical formula —C₄H₉, polyisobutylene and a rosin ester.

80. The composition according to claim 79, wherein said butyl is selected from the group consisting of n-butyl, sec-butyl (1-methylpropyl), isobutyl (2-methylpropyl), tert-butyl/t-butyl (1,1-dimethyllethyl) and any isomer of the foregoing.

81. The composition according to claim 2, wherein said at least one additional rubber-based material is provided in an amount of about 10 phr.

82. The composition according to claim 2, wherein said at least one temperature/heat stabilizer is provided in an amount of about 0.1 phr.

83. The composition according to claim 2, wherein said at least one temperature/heat stabilizer comprises at least one material selected from the group consisting of antioxidants and stabilizers.

84. The composition according to claim 83, wherein said at least one temperature/heat stabilizer is selected from the group consisting of a phosphite antioxidant/stabilizer, thiodiethylene bis [3-(3,5-di-tert-butyl-4-hydroxyphenyl)propionate], and derivatives of the foregoing.

85. The composition according to claim 2, wherein said at least two reactive curing agents comprise a first reactive curing agent and a second reactive curing agent, said first reactive curing agent and said second reactive curing agent being different and comprising a material selected from the group consisting of a reactive polyethylene, glycidyl methacrylate (GMA), maleic anhydride (MAH) groups, peroxides, tert-butyl peroxybenzoate (TBPB), cycloaliphatic epoxides, cycloaliphatic diepoxide, a high molecular weight polymer, high molecular weight EPDM and RCP polypropylene.

86. The composition according to claim 85, wherein said first reactive curing agent is glycidyl methacrylate and said second reactive curing agent is maleic anhydride.

87. The composition according to claim 2, wherein each of said at least two reactive curing agents are provided in an amount of about 3.75 phr.

88. The composition according to claim 2, further comprising a higher molecular weight polymer for substituting said at least two reactive curing agents.

89. The composition according to claim 88, wherein said higher molecular weight polymer is selected from the group consisting of high ethylene EPDM and RCP polypropylene.

90. The composition according to claim 2, wherein said additional plasticizer material is a non-blooming plasticizer comprising a rapidly renewable content and being devoid of halogens and phthalates.

91. The composition according to claim 2, wherein said additional plasticizer is provided in an amount of about 15 phr.

92. The composition according to claim 2, wherein said additional plasticizer is selected from the group consisting of oils composed of alkanes (15-40 carbons), cyclic paraffins, mineral oil, paraffin oil, polymer modifiers, sun oil, vegetable oil, soy, linseed oil, corn oil and a wax substitute of the foregoing.

93. The composition according to claim 92, wherein said polymer modifiers are hydrocarbon fluids.

94. The composition according to claim 3, wherein said at least one temperature/heat stabilizer is provided in an amount of about 0.1-0.4 phr.

95. The composition according to claim 3, wherein said at least one temperature/heat stabilizer is selected from the group consisting of a phosphite antioxidant/stabilizer, thiodiethylene bis [3-(3,5-di-tert-butyl-4-hydroxyphenyl)propionate], and derivatives of the foregoing.

96. The composition according to claim 3, wherein said coloring agents are provided in an amount of about 0.8 phr.

97. The composition according to claim 3, wherein said coloring agents are pure color pigments.

98. The composition according to claim 3, wherein said lubricant comprises a non-flammable lubricant being devoid of halogens and phthalates.

99. The composition according to claim 3, wherein said lubricant is a free acid organic phosphate ester.

100. The composition according to claim 3, wherein said lubricant is provided in an amount of about 3-4 phr.

101. The composition according to claim 1, wherein said composition is manufactured by a method selected from the group consisting of sheet extrusion, thermoforming, injection molding, calendering, profile extrusion, blow molding, and casting.

102. A composition for manufacturing a flooring accessory, said composition comprising a first formulation and a second formulation that are cured together to form said composition, wherein said composition is devoid of halogens and devoid of phthalates, wherein said first formulation comprises a rubber-based elastomeric material, a first olefinic polymer, a polymeric plasticizer, at least one second olefinic polymer which is different from or the same as said first olefinic polymer provided, a flame retardant system comprising at least one flame retardant material, a smoke suppressant/char former material, and a resiliency reducer/adhesion promoter; and wherein said second formulation comprises a first olefinic polymer, a second olefinic polymer being the same as or different from the first olefinic polymer, a polymeric plasticizer, a compatibilizer, at least one third olefinic polymer being the same as or different from the first and/or second olefinic polymer, a durability promoter, a flame retardant system comprising at least one flame retardant material, a smoke suppressant/char former material and a stabilizer, wherein said composition and said flooring accessory made with said composition is non-PVC, halogen-free, phthalate-free, reprocessable and comprises a rapidly renewable content, and wherein said composition components so mixed as to be sufficiently adhesive to avoid adhesive deterioration over extended periods of time while in storage, said composition is mixed in such proportions as to be flame retardant, and sufficiently soft and flexible to yield aesthetic flooring accessories.

103. The composition according to claim 102, wherein said first formulation further comprises at least one additional rubber-based material, at least one temperature/heat stabilizer, at least two reactive curing agents, at least one filler material, at least one additive, at least one weight reducer material, a stabilizer, at least one lubricant and an additional plasticizer, wherein said composition is in such proportions as to be commercially extrudable, and is devoid of rubber processing additives including amine accelerators, vinyl benzene, natural rubber allergens, sulfur, phthalates, halogens and/or bovine spongiform encephalophines.

104. The composition according to claim 102, wherein said second formulation further comprises coloring agents, at least one lubricant and a temperature stabilizer, wherein said composition is in such proportions as to be commercially extrudable, and is devoid of rubber processing additives including amine accelerators, vinyl benzene, natural rubber allergens, sulfur, phthalates, halogens and/or bovine spongiform encephalophines.
